(19) United States
(12) Patent Application Publication
(10) Pub. No.: US 2008/0161048 A1
(43) Pub. Date: Jul. 3, 2008

(54) Wireless Handheld Communication Device

(75) Inventor: Chih-Hung Chuang, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTEK COMPUTER INC., Taipei (TW)

(21) Appl. No.: 11/934,270

(22) Filed: Nov. 2, 2007

(30) Foreign Application Priority Data
Dec. 29, 2006 (TW) 95150013

(51) Int. Cl. G06F 1/16

(52) U.S. Cl. 455/557

(57) ABSTRACT

A wireless handheld communication device is described. A main body has a first interfering portion in inner walls thereof. A keyboard structure has a frame and a flexible body, wherein the plastic frame has a second interfering portion for engaging with the first interfering portion so as to fix the keyboard structure in the main body.

### RELATED APPLICATIONS

This application claims priority to Taiwan Application Serial Number 95150013, filed Dec. 29, 2006, which is herein incorporated by reference.

### BACKGROUND OF THE INVENTION

1. Field of the Invention

The invention relates to a wireless handheld communication device and, more particularly, to a keyboard structure of a wireless handheld communication device.

2. Description of the Related Art

A wireless handheld communication device (such as a GSM mobile phone) usually can satisfy communication standards worldwide. However, language symbols on the keys of a mobile phone are various according to different languages.

Mobile phone providers worldwide often need to prepare some storage of mobile phones with different language symbols to meet urgent demand. The storage makes a cost pressure on the mobile phone providers. If the mobile phone providers do not prepare some storage of mobile phones with different languages, they cannot provide goods in time when an urgent order arrives. Therefore, mobile phone providers are in a dilemma.

### BRIEF SUMMARY OF THE INVENTION

One objective of the invention is to provide a wireless handheld communication device, so that the time for assembling the keyboard structure and the main body can be reduced.

According to the objective of the invention, a wireless handheld communication device including a main body and a keyboard structure is provided. The inner wall of the main body has a first interfering portion. The keyboard structure has a frame and a flexible body embedded at the frame, wherein the frame has a second interfering portion for engaging with the first interfering portion, so that the keyboard structure can be fixed on the main body. When the keyboard structure is assembled at the main body, the flexible body of the keyboard structure can deform to enable the frame to be fastened with the main body successfully.

According to one embodiment of the invention, the frame can be a plastic frame, and the flexible body can be a silica gel body. The first interfering portion can be a pair of recesses, and the second interfering portion can be a pair of protrudent blocks. The keyboard structure further includes a silica gel protecting cover for covering the side walls of the main body.

### BRIEF DESCRIPTION OF THE DRAWINGS

These and other features, aspects, and advantages of the present invention will become better understood with regard to the following description, appended claims, and accompanying drawings.

FIG. 1 shows a wireless handheld communication device of one preferred embodiment of the invention.

FIG. 2 shows a keyboard structure of one preferred embodiment of the invention.

FIG. 3 is a section diagram showing a wireless handheld communication device of one preferred embodiment of the invention.

### DETAILED DESCRIPTION OF THE EMBODIMENTS

As stated above, the invention provides a wireless handheld communication device which has a keyboard structure made by double (plastic and silica gel) injection. Wireless handheld communication devices with different languages can be provided in time, as long as any parts are assembled except for the keyboard structures, and then the corresponding keyboard structures are assembled quickly according to the demands from various regions. Then, the needed storage is reduced.

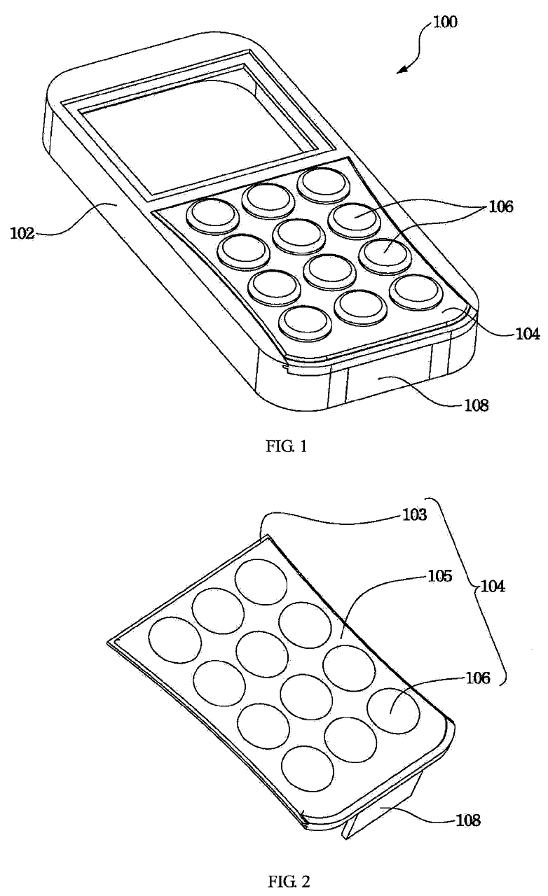

Please refer to FIG. 1 showing a wireless handheld communication device according to one preferred embodiment of the invention. The wireless handheld communication device 100 includes an assembled main body 102 and a keyboard structure 104 having a plurality of keys 106. Different language symbols are printed to the keys 106 of the keyboard structure 104 for different languages. The keyboard structure 104 also can include a protecting cover 108 made by silica gel (perpendicular to the plastic frame 103 and extending outwards) for covering the connector socket (such as a charging socket) on the main body 102 to protect the connector socket from water or dust.

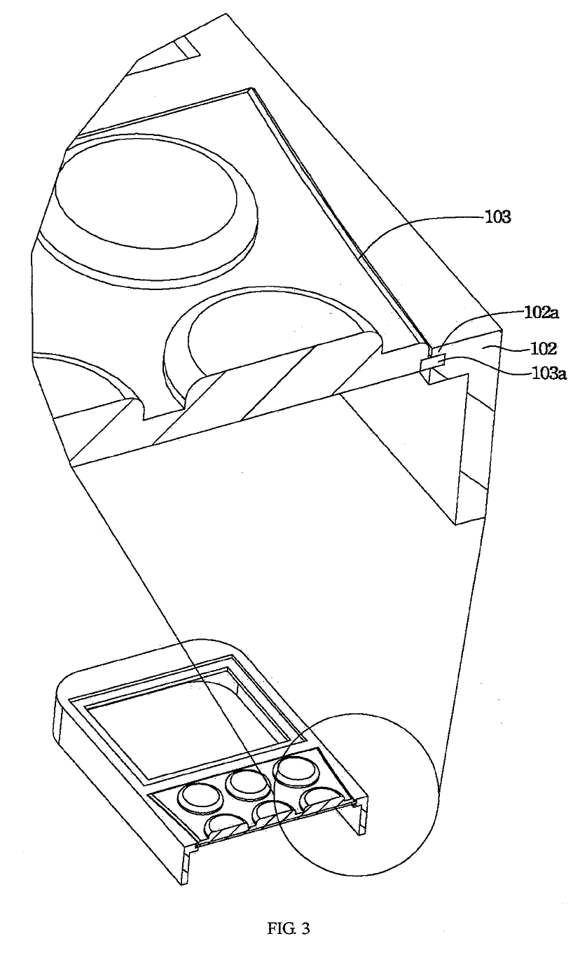

Please refer to FIG. 2 showing a keyboard structure of one preferred embodiment of the invention. The keyboard structure 104 is made by double (plastic and silica gel) injection and has a plastic frame 103 and a silica gel body 105. A plurality of keys 106 are provided on the silica gel body 105, and the flexibility needed when the keys are pressed is provided by the flexibility of the silica gel. In addition, the silica gel body 105 also provides proper flexibility for the keyboard structure 104, so that the plastic frame 103 can be assembled with the main body 102 easily.

Please refer to FIG. 3 which is a section diagram showing a wireless handheld communication device of one preferred embodiment of the invention. FIG. 3 shows the assembly structure of the keyboard structure 104 and the main body 102. The plastic frame 103 of the keyboard structure 104 has an second interfering portion 103a for engaging with an first interfering portion 102a of the main body 102, so that the keyboard structure 104 can be fixed on the main body 102. The second interfering portion 103a can be a protrudent block, while the first interfering portion 102a can be a recess (as shown in FIG. 3), or the second interfering portion 103a can be a recess, while the first interfering portion 102a can be a protrudent block (not shown). A pair of interfering portions 102a is formed at the two sides of the inner walls of the main body 102, respectively, and at least one of them extends arcuately in the main body 102. A pair of interfering portions 103a is formed at the two sides of the plastic frame 103, and at least one of them extends arcuately in the plastic frame 103. The objective of extension to be arcuate is to make the keyboard structure 104 be steadily fastened with the main body 102.

From the preferred embodiment of the invention, we can know that applying the keyboard structure made by double (plastic and silica gel) injection of the invention facilitates the assembly of the keyboard structure and main body and decreases the time for assembling the keyboard structure and the main body.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A wireless handheld communication device comprising:
a main body whose inner walls having a first interfering portion; and
a keyboard structure having a frame and a flexible body embedded at the frame, wherein the frame has a second interfering portion for engaging with the first interfering portion, so that the keyboard structure can be fixed at the main body.

2. The wireless handheld communication device according to claim 1, wherein the first interfering portion is a pair of recesses.

3. The wireless handheld communication device according to claim 1, wherein the frame is a plastic frame.

4. The wireless handheld communication device according to claim 1, wherein the second interfering portion is a pair of protrudent blocks.

5. The wireless handheld communication device according to claim 1, wherein the flexible body is a silica gel body.

6. The wireless handheld communication device according to claim 1, wherein the keyboard structure further comprises a protecting cover for covering side walls of the main body.

7. The wireless handheld communication device according to claim 6, wherein the protecting cover is made of silica gel.

8. The wireless handheld communication device according to claim 1, wherein the flexible body has a plurality of keys.

9. The wireless handheld communication device according to claim 1, wherein the first interfering portion is a pair of protrudent blocks.

10. The wireless handheld communication device according to claim 1, wherein the second interfering portion is a pair of recesses.
